(19) United States
(12) Patent Application Publication
(10) Pub. No.: US 2010/0030489 A1
(43) Pub. Date: Feb. 4, 2010

(54) SYSTEM FOR ANALYZING/INSPECTING AIRBORNE RADIOACTIVE PARTICLES SAMPLED IN A DRAFT FLUE

(75) Inventors: YI-FU CHIOEU, Taoyuan County (TW); HSIN-FA FANG, Taoyuan County (TW); ING-JANE CHEN, Taoyuan County (TW); TZONG-LIANG PAN, Taoyuan County (TW); KUN-HSUAN LIANG, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/259,353

(22) Filed: Oct. 28, 2008

(30) Foreign Application Priority Data
Aug. 1, 2008 (TW) 097213781

(51) Int. Cl. G06F 19/00; G01T 7/00

(52) U.S. Cl. 702/30; 250/336.1

(57) ABSTRACT

A system for analyzing/inspecting airborne radioactive particles sampled in a draft flue is disclosed, which comprises: a front detector, at least an air intake tube, a capture vessel, an inspection device, a flow meter, a hand-held electric device, a blower motor, With the aforesaid system, the radioactivity distribution relating to the airborne particles as well as the peak of the distribution can be detected, by which a sampling time can be determined for achieving longer period of time allowed for an analysis to be performed while rejecting the radioactive interference in the draft flue. Thereby, background noise relating to ambient radioactivity can be minimized and thus the detection limit of the aforesaid system is reduced, so that the system of the invention is much more sensitive compared to those conventional real-time radioactivity detection means with regard to the detection of radioactive nuclides in airborne particles.

### FIELD OF THE INVENTION

The present invention relates to a system for analyzing/inspecting airborne radioactive particles sampled in a draft flue, and more particularly, to a system capable of using a pre-detector for detecting the radioactivity distribution relating to the airborne radioactive particles as well as the peak of the distribution while using the detection to determine a sampling time for obtaining representative samples of the airborne radioactive particles in the draft flue. In addition, as the acquired samples are stored in a capture vessel, a longer period of time allowed for an analysis to be performed can be achieved while preventing the radioactive interference in the draft flue referring especially to the radioactivity caused by those airborne radioactive particles accumulated in the air filter or on the inner wall of the draft flue. Thereby, background noise relating to ambient radioactivity can be minimized and thus the detection limit of the aforesaid system is reduced, so that the system of the invention is much more sensitive compared to those conventional real-time radioactivity detection means with regard to the detection of radioactive nuclides in airborne particles. Moreover, the system of the invention is able to identify the type of radionuclide floating in the airborne radioactive particles

### BACKGROUND OF THE INVENTION

With rapid advance of nuclear technology, the related applications are developed from smoke detectors to nuclear reactors, and from gun sights to nuclear weapons, not to mention that it is being vastly applied in various medical uses. With the popularization of such radioactive medical apparatuses, they can easily be found even in those densely populated urban area and consequently there are more and more people who are living or working near a radioactive source but not aware of that. As the operation of any nuclear facilities/apparatuses is going to cause the emission of certain airborne radioactive materials, such emission might cause a certain degree of radiation exposure to its neighboring environment and people so that the concentration of such airborne radioactive materials must be sampled and controlled for ensuring the same to meet with a radiation safety standard and regulation defined by relating nuclear regulatory authority. As the use of positron emission tomography (PET) in the diagnosis of tumors, heart diseases, nerve-related diseases, and even mental diseases has achieved outstanding results, PET devices are becoming the must-have diagnosis apparatuses for almost every hospitals that there is a great deal of public concern about its possible implications relating to radioactive contamination. Among such concerns, the direct radiation leakage from those nuclear medical apparatuses as they are under normal operations can already be controlled effectively since there are already many effective radiation shielding devices especially designed for those nuclear medical apparatuses. However, there are still no solutions for the emission of airborne radioactive materials. Taking a positron circular accelerator for instance, its tube wall as well as the air filled therein will be activated by the neutrons generated from the nuclear reactions during each operation process of the positron circular accelerator, such as the charged particles is circulating, being separated, being synthesized or hitting on a target, which is going to cause a certain radioactive materials to be generated and thus airborne. If no proper precausious action is taken for processing such airborne radioactive materials before they are discharged freely into ambient environment, the people and the environment near the circular accelerator is going to be subjected to hadzardous radiation exposure. Therefore, it is important to have the relating nuclear regulatory authority to design a specification for regulating the discharging and processing of such airborne radioactive materials.

In order to effectively regulate the discharging of such airborne radioactive material, it is important to have a decent system that is capable of analyzing and inspecting airborne radioactive particles sampled from a draft flue so as to monitor whether there is an abnormal discharging or to detect whether the filtering device is operating as expected for contamination prevention. However, for those devices for discharging airborne radioactive material that are currently available, the radioactivity of those airborne radioactive materials that are to be discharged is only being monitored and detected by a simple detector arranged at the end of their discharging pipe. Thus, since the timing and volume of airborne radioactive materials to be discharged for different operations in a radioactive apparatus can be different, not to mention that the discharged airborne radioactive material can be dissipated in air rapidly when it is discharged by a large-volume draft flue, it is difficult and almost impossible to determine whether the radioactivity of the discharged airborne radioactive materials is exceeding the defined radiation safety standard and regulation or not. In addition, as allowable emission concentration relating to the discharging of the airborne radioactive materials for different positron-emitting nuclides are not the same despite that their energy peaks are all at 511 keV, it is important to have a system capable of identifying different nuclides from each other by the use of their decay characteristic so as to define a proper allowable emission concentration.

Therefore, it is in need of a system for analyzing/inspecting airborne radioactive particles sampled in a draft flue, capable of using a pre-detector for detecting the radioactivity distribution relating to the airborne radioactive particles as well as the peak of the distribution while using the detection to determine a sampling time for obtaining representative samples of the airborne radioactive particles in the draft flue. In addition, as the acquired samples are stored in a capture vessel, a longer period of time allowed for an analysis to be performed can be achieved while preventing the radioactive interference in the draft flue referring especially to the radioactivity caused by those airborne radioactive particles accumulated in the air filter or on the inner wall of the draft flue. Thereby, background noise relating to ambient radioactivity can be minimized and thus the detection limit of the aforesaid system is reduced, so that the system of the invention is much more sensitive compared to those conventional real-time radioactivity detection means with regard to the detection of radioactive nuclides in airborne particles. Moreover, the system of the invention is able to identify the type of positron-emitting nuclide floating in the airborne radioactive particles by the counting obtained from different time zones and the decay characteristic of different nuclides. With the software and processes embedded in the system of the invention, the system is able to work cooperatively with those existing laboratory equipments in a manner that not only the exactness of sampling and the detection limit for inspection and analysis are improved, but also the environment protection requirements regulated by the authority are achieved.

### SUMMARY OF THE INVENTION

In view of the disadvantages of prior art, the primary object of the present invention is to provide a system for analyzing/inspecting airborne radioactive particles sampled in a draft flue, capable of using the operations of a pre-detector, a flow meter and a detector to generate and output a parameter relating to the amount of airborne particles to a hand-held electric device for activating a software programmed therein to perform a calculation while outputting a control signal accordingly to a blow motor for controlling the ON/OFF of the same.

Another object of the invention is to provide a system configured with a detector with airborne particle detection ability and a hand-held electric device embedded with a software, so that system is enabled to use the hand-held electric device to perform a calculation according to the detection of the detector for obtaining values relating to the peak amount of airborne particles being discharged, the total amount of airborne particle being discharged as well as the high time when the airborne particles is being discharged, and thus adapting the same for analyzing/inspecting airborne radioactive particles sampled in all kinds of draft flues.

To achieve the above object, the present invention provides a system for analyzing/inspecting airborne radioactive particles sampled in a draft flue, which comprises:
a pre-detector, for detecting and inspecting airborne radioactivity of the draft flue so as to output a detection value relating to the detection;
an air intake tube, configured with an inlet for collecting airborne particles from a discharge area;
a capture vessel, connected with the air intake tube for receiving the collected particles therefrom;
a detector, for inspecting and measuring a radiation dose relating to the airborne radioactivity in the capture vessel so as to obtain an analysis relating to its spectrum distribution and radioactivity intensity while outputting numerical values of the analysis according to the inspection;
a flow meter, for measuring an airborne flow rate while outputting the same;
a hand-held electric device, for receiving values outputted from the pre-detector, the detector and the flow meter while feeding the received values to a software programmed in the hand-held electric device for performing a calculation therewith and thus outputting a control signal according to the calculation;
a blower motor, for receiving the control signal from the hand-held electric device to be used for controlling the ON/OFF of the same in a manner the collected airborne particles used as sample is fed back to an intake area of the draft flue; and
a sample outlet, for discharging the sample in the capture vessel to the intake area of the draft flue.

Preferably, the capture vessel is vacuumed for minimizing any residue particles and thus preventing the affection of exchanging rate from diluting the radioactivity of the collected airborne particles.

Preferably, the capture vessel is constructed as a piston structure for freeing the same from any airborne particle residue problem as it is able to achieve a vacuuming effect while enabling the same to change the volume of the airborne particles to be sampled in a dynamic manner.

Preferably, the capture vessel is constructed as a multi-cell structure to be used for sequentially connecting the sampled airborne particles into different cells according to a specific time sequence.

Preferably, the capture vessel is constructed as a spiral coil structure to be used for increasing the time required for the sampled airborne particles to pass through the detector and thus enhancing the detection efficiency.

Preferably, the hand-held electric device is a device capable of communicating with a control unit as well as a digital processor that is a device selected from the group consisting of: a notebook computer, an ultra-mobile person computer (UMPC), a personal digital assistant (PDA), a netbook computer, and a smart phone.

Preferably, each of the pre-detector, the detector, the flow meter, the blow motor the hand-held electric device is configured with a wireless transmission device to be used for transmitting electric signal in a wireless manner, and thereby, preventing any cable entanglement problem from happening.

Preferably, the wireless transmission device uses a technique selected from the group consisting of: Bluetooth transmission, Infrared transmission, radio frequency transmission, WiFi, WiMAX, and ZigBEE.

Preferably, the hand-held electric device is programmed with a software for performing a calculation to obtain values relating to the peak amount of airborne particles being discharged, the total amount of airborne particle being discharged as well as the high time when the airborne particles is being discharged according to the detection value obtained from the detection of the pre-detector in a manner that values relating to the total radioactivity of the airborne particle being discharged, the average radioactivity during the high time when the airborne particles is being discharged and the radioactivity at the time when airborne particles being discharged reaches its peak.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a functional block diagram depicting a system for analyzing/inspecting airborne radioactive particles sampled in a draft flue according to an exemplary embodiment of the invention.

FIG. 2 is a diagram profiling the variation of the radioactive intensity detected by the pre-detector as well as the times relating to when the blow motor is being turned ON and OFF according to evaluation performed by the software embedded in the hand-held electric device while the variation is received by the same.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

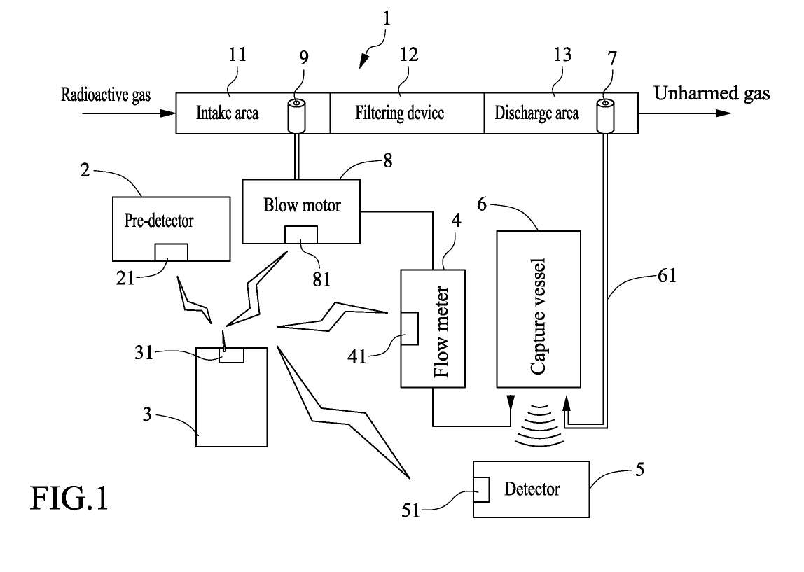

Please refer to FIG. 1, which is a functional block diagram depicting a system for analyzing/inspecting airborne radioactive particles sampled in a draft flue according to an exemplary embodiment of the invention. The system of FIG. 1 comprises: a pre-detector 2, disposed at a side of an intake area 11 of a draft flue 1 to be used for radioactivity sampling while outputting the result accordingly; the draft flue 1, provided for airborne radioactive particles to pass therethrough, being comprised of the intake area 11, a filtering device 13 and a discharge area 13 while in the discharge area 13, an air intake tube 7 is being configured thereat to be used for outputting the sampled airborne radioactive particles as it is connected to a capture vessel 6 by a pipe 61; the capture vessel 6, connected with the air intake tube 7 for collecting the sampled airborne radioactive particles to be used in a radioactivity spectrum analysis so that the spectrum distribution relating to the sampled airborne radioactive particles as well as the relating intensity can be obtained; a detector 5, for inspecting and measuring a radiation dose relating to the airborne radioactivity in the capture vessel 6 so as to obtain an analysis relating to its spectrum distribution and radioactivity intensity while outputting numerical values of the analysis according to the inspection; a flow meter 4, for measuring an airborne flow rate while outputting the same; a hand-held electric device 3, for receiving values outputted from the pre-detector 2, the detector 5 and the flow meter 4 while feeding the received values to a software programmed in the hand-held electric device 3 for performing a calculation therewith and thus outputting a control signal according to the calculation; a remote-control blow motor 8, for receiving the control signal from the hand-held electric device 3 to be used for controlling the ON/OFF of the same. Moreover, the capture vessel 6 can be constructed as following: (1) it is vacuumed; (2) it is constructed as a piston structure; (3) it is constructed as a multi-cell structure; (4) it is constructed as a spiral coil structure. In addition, the hand-held electric device 3 can be a device selected from the group consisting of: a notebook computer, a ultra-mobile personal computer (UMPC), a personal digital assistant (PDA), a netbook computer and a smart phone.

In an exemplary embodiment, each of the pre-detector 2, the detector 5, the flow meter 4, the blow motor 8 and the hand-held electric device 3 is configured with a wireless transmission device to be used for transmitting electric signal in a wireless manner, whereas the wireless transmission device uses a technique selected from the group consisting of: Bluetooth transmission, Infrared transmission, radio frequency transmission, WiFi, WiMAX, and ZigBEE.

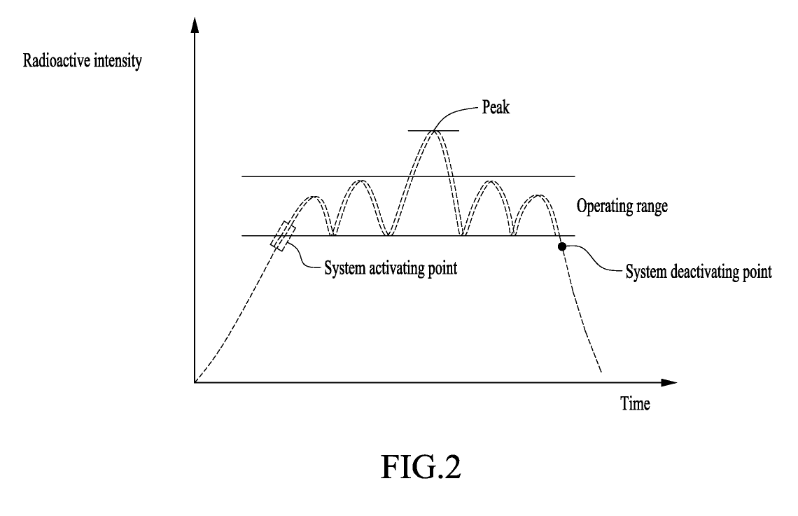

Please refer to FIG. 2, which is a diagram profiling the variation of the radioactive intensity detected by the pre-detector as well as the times relating to when the blow motor is being turned ON and OFF according to evaluation performed by the software embedded in the hand-held electric device while the variation is received by the same. The profile of FIG. 2 shows the relation between the radioactivity variation and time. As the radioactive intensity detected by the pre-detector 2 is sent to the hand-held electric device 3, it will enable the software embedded therein to perform an analysis upon the received data so as to obtain an evaluation regarding to the status of the radioactivity variation for determining whether the intensity is increasing, decreasing or stabilized while basing upon the evaluation to determining a proper sampling time for obtaining representative samples of the airborne radioactive particles in the draft flue. Preferably, the hand-held electric device 3 is programmed with a software for performing a calculation to obtain values relating to the peak amount of airborne particles being discharged, the total amount of airborne particle being discharged as well as the high time when the airborne particles is being discharged according to the detection value obtained from the detection of the pre-detector in a manner that values relating to the total radioactivity of the airborne particle being discharged, the average radioactivity during the high time when the airborne particles is being discharged and the radioactivity at the time when airborne particles being discharged reaches its peak. By the evaluation obtained from software programmed in the hand-held electric device 3, a control signal is issued for controlling the ON/OFF of the blow motor 8. When the blow motor 8 is activated for intaking, the airborne radioactive particles floating in the discharge area 13 of the draft flue will be drawn to enter the capture vessel 6 from the air intake tube 7, during which the excess portion of the sample along with the portion of the sample whichever is being inspected will be transferred back to the intake area 11 of the draft flue 1 from a sample outlet 9. It is noted that the software of the hand-held electric device 3 is programmed to activate the blow motor 8 when the radioactive intensity is increasing and reaches a specific value or reaches its stabilized high time; and it is programmed to deactivated the blow motor 8 when the radioactive intensity is decreasing and reaches another specific low value; thereby, it can ensure the sample in the capture vessel 6 is collected at the time when the radioactivity of the airborne radioactive particles is at its peak.

From the above description, the present invention provides a system for analyzing/inspecting airborne radioactive particles sampled in a draft flue, capable of using the operations of a pre-detector, a flow meter and an detector to generate and output a parameter relating to the amount of airborne particles to a hand-held electric device for activating a software programmed therein to perform a calculation while outputting a control signal accordingly to a blow motor for controlling the ON/OFF of the same. In addition, as the system is configured with an detector with airborne particle detection ability and a hand-held electric device embedded with a software, the system is able to use the hand-held electric device to perform a calculation according to the detection of the detector for obtaining values relating to the peak amount of airborne particles being discharged, the total amount of airborne particle being discharged as well as the high time when the airborne particles is being discharged, and thus adapting the same for analyzing/inspecting airborne radioactive particles sampled in all kinds of draft flues.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A system for analyzing/inspecting airborne radioactive particles sampled in a draft flue, comprising:
a pre-detector, for detecting and inspecting airborne radioactivity of the draft flue so as to output a detection value relating to the detection;
an air intake tube, configured with an inlet for collecting airborne particles from a discharge area;
a capture vessel, connected with the air intake tube for receiving the collected particles therefrom to be used as a sample;
a sample outlet, connected to the capture vessel for discharging the excess portion of the sample along with the portion of the sample whichever is being inspected back to the draft flue;
a detector, for inspecting and measuring a radiation dose relating to the airborne radioactivity in the capture vessel so as to obtain an analysis relating to its spectrum distribution and radioactivity intensity while outputting numerical values of the analysis accord to the inspection;
a flow meter, for measuring an airborne flow rate while outputting the same;
a hand-held electric device, for receiving values outputted from the pre-detector, the detector and the flow meter while feeding the received values to a software programmed in the hand-held electric device for performing a calculation therewith and thus outputting a control signal according to the calculation;
a software, adapted for analyzing information obtained from the pre-detector in a manner that the evaluation is made for determine whether the radioactivity of the airborne particles is raising or dropping according to the detection value outputted from the pre-detector while basing upon the evaluation to determine a sampling time for obtaining the sample of the airborne particles in the draft flue; and using the detection value outputted from the pre-detector to perform a calculation for obtaining values relating to the peak amount of airborne particles being discharged and the high time when the airborne particles is being discharged; and by combining with data relating to the total amount of the airborne particles being discharged, another evaluation is performed for obtaining values relating to the total radioactivity of the airborne particle being discharged, the average radioactivity during the high time when the airborne particles is being discharged and the radioactivity at the time when airborne particles being discharged reaches its peak.
a blower motor, for receiving the control signal from the hand-held electric device to be used for controlling the ON/OFF of the same in a manner the collected airborne particles used as sample is fed back to an intake area of the draft flue.

2. The system of claim 1, wherein the capture vessel is vacuumed.

3. The system of claim 1, wherein the capture vessel is constructed as a piston structure.

4. The system of claim 1, the capture vessel further comprises a plurality of absorbents.

5. The system of claim 1, wherein the capture vessel is constructed as a multi-cell structure.

6. The system of claim 1, wherein the capture vessel is constructed as a spiral coil structure.

7. The system of claim 1, wherein the hand-held electric device is a device selected from the group consisting of: a notebook computer, an ultra-mobile person computer (UMPC), a personal digital assistant (PDA), a netbook computer, and a smart phone.

8. The system of claim 1, wherein each of the pre-detector, the detector, the flow meter, the blow motor is configured with a wireless transmission device to be used for transmitting electric signal in a wireless manner.

9. The system of claim 1, wherein the wireless transmission device uses a technique selected from the group consisting of: Bluetooth transmission, Infrared transmission, radio frequency transmission, WiFi, WiMAX, and ZigBEE.

10. The system of claim 8, wherein the software programmed in the hand-held electric device is capable of analyzing the detection of the pre-detector so as to obtain values relating to the total amount of airborne particles being discharged, the peak amount of airborne particles being discharged, the total amount of airborne particle being discharged as well as the high time when the airborne particles is being discharged in a manner that values relating to the total radioactivity of the airborne particle being discharged, the average radioactivity during the high time when the airborne particles is being discharged and the radioactivity at the time when airborne particles being discharged reaches its peak.
